(19) United States
(12) Patent Application Publication
(10) Pub. No.: US 2012/0206351 A1
(43) Pub. Date: Aug. 16, 2012

(54) INFORMATION PROCESSING APPARATUS, COMPUTER-READABLE STORAGE MEDIUM HAVING STORED THEREIN INFORMATION PROCESSING PROGRAM, INFORMATION PROCESSING METHOD, AND INFORMATION PROCESSING SYSTEM

(75) Inventors: Keizo OHTA, Kyoto (JP); Taiyo HARA, Kyoto (JP); Masaaki TATSUMI, Kyoto (JP)

(73) Assignee: NINTENDO CO., LTD., Kyoto (JP)

(21) Appl. No.: 13/093,553

(22) Filed: Apr. 25, 2011

(30) Foreign Application Priority Data
Feb. 15, 2011 (JP) 2011-029786

(51) Int. Cl. G06F 3/033

(52) U.S. Cl. 345/158

(57) ABSTRACT

A first housing including an orientation detection section for detecting an orientation, and a second housing including a screen section for displaying a predetermined image are connected to each other such that the relative orientation of the second housing with respect to the first housing can be changed. The relative orientation of the second housing is estimated based on a value obtained by adding a predetermined offset to detected data detected by the orientation detection section, and predetermined display processing is performed for the screen section, based on the relative orientation of the second housing.

### CROSS REFERENCE TO RELATED APPLICATION

The disclosure of Japanese Patent Application No. 2011-029786, filed on Feb. 15, 2011, is incorporated herein by reference.

### BACKGROUND OF THE INVENTION

### Field of the Invention

The present invention relates to an information processing apparatus, and more particularly, to information processing performed by an information processing apparatus including two housings.

### Description of the Background Art

Conventionally, game apparatuses including a gyrosensor are known (for example, Japanese Laid-Open Patent Publication No. 2006-68027). In such game apparatuses, the inclination of a game apparatus is detected by a gyrosensor, and game processing using the inclination is performed.

However, a game apparatus disclosed in Japanese Laid-Open Patent Publication No. 2006-68027 includes one housing. That is, the game apparatus is based on the assumption that the one housing includes a screen for displaying a game image, components such as operation buttons used for operation, and a gyrosensor. Therefore, the game apparatus does not take into consideration, for example, a game apparatus including two housings that are openable and closable, only one of which housings includes a gyrosensor. In light of this respect, in the case where such a game apparatus including two housings one of which includes a gyrosensor varies a game image in accordance with the inclination of the housing including the gyrosensor, the present applicant has discovered that there is room for improvement in a manner of using the inclination and in a manner of displaying the game image.

### SUMMARY OF THE INVENTION

Therefore, an object of the present invention is to provide an information processing apparatus that is capable of, even if the information processing apparatus includes two housings only one of which includes a sensor, such as a gyrosensor, capable of detecting an orientation, performing information processing using an orientation of the housing that does not include the sensor.

The present invention has the following features to attain the object mentioned above.

An information processing apparatus according to the present invention comprises: a first housing, a second housing, a second housing orientation calculation section, and a display processing section. The first housing includes an orientation detection section for detecting an orientation. The second housing includes a first screen section for displaying a predetermined image, and is connected to the first housing such that a relative orientation of the second housing with respect to the first housing can be changed. The second housing orientation calculation section calculates second housing orientation data indicating the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data. The display processing section performs predetermined display processing for the first screen section, based on the second housing orientation data.

According to the above configuration, it is possible to estimate the orientation of the housing that does not include the orientation detection section, and to perform screen display processing based on the estimated orientation, without providing orientation detection sections in the respective two housings.

In another configuration example, the information processing apparatus may further comprise: a relative orientation information inputting section for causing a player to input relative orientation information indicating the relative orientation of the second housing with respect to the first housing; and an offset setting section for setting the value of the predetermined offset, based on the relative orientation information inputted by the player. The second housing orientation calculation section may calculate the second housing orientation data by using the predetermined offset set by the offset setting section.

According to the above configuration example, it is possible to execute information processing in accordance with the direction of the second housing which does not include the orientation detection section.

In another configuration example, the information processing apparatus may be a foldable-type information processing apparatus including the first housing and the second housing connected to each other so as to be openable and closable, and the relative orientation information inputting section may cause the player to input, as the relative orientation information, a value indicating a relative opening angle of the second housing with respect to the first housing.

According to the above configuration example, an information processing apparatus of a foldable type can execute screen display processing in accordance with its opening angle.

In another configuration example, the information processing apparatus may further comprise: a relative orientation detection section for detecting a relative orientation of the second housing with respect to the first housing, and outputting the relative orientation as relative orientation information; and an offset setting section for setting, as the predetermined offset, a value corresponding to the relative orientation of the second housing which is indicated by the relative orientation information. The second housing orientation calculation section may calculate the second housing orientation data by using the predetermined offset set by the offset setting section.

According to the above configuration example, it is possible to execute screen display processing in accordance with the orientation of the housing that does not include the orientation detection section.

In another configuration example, the relative orientation detection section may output, as the relative orientation information, information indicating a relative direction of the second housing with respect to the first housing.

According to the above configuration example, it is possible to execute screen display processing in accordance with the direction of the housing that does not include the orientation detection section.

In another configuration example, the information processing apparatus may be a foldable-type information processing apparatus including the first housing and the second housing connected to each other so as to be openable and closable, and the relative orientation detection section may detect a relative opening angle of the second housing with respect to the first housing, and may output the relative opening angle as the relative orientation information.

According to the above configuration example, an information processing apparatus of a foldable type can execute information processing associated with its opening angle.

In another configuration example, the display processing section may include: a camera setting section for setting a shooting direction of a virtual camera placed in a virtual space; and an image outputting section for outputting an image of the virtual space shot by the virtual camera to the first screen section, and the camera setting section may set the shooting direction of the virtual camera in accordance with an orientation of the first screen section, which orientation is calculated based on the relative orientation of the second housing or a variation in the relative orientation.

According to the above configuration example, it is possible to execute information processing of, for example, when the information processing apparatus itself is moved, varying an image displayed on the first screen section in accordance with the orientation of the first screen section (second housing). In addition, in this processing, it is possible to reduce a feeling of strangeness about a relationship between the direction of the screen section and the content of an image displayed on the screen section.

In another configuration example, the first housing may further include an operation section for designating a movement direction of a player object in a virtual space, and the display processing section may include: an image outputting section for outputting, to the first screen section, an image, of the virtual space in which at least the player object is present, that is shot by the virtual camera; and a movement direction adjustment section for varying a correspondence relationship between the movement direction of the player object in the virtual space, and an input direction of the operation section, in accordance with the detected data, or in accordance with the orientation of the first housing or the variation in the orientation, which orientation is calculated based on the detected data.

According to the above configuration example, in processing (for example, game processing) of varying an image displayed on the screen section in accordance with a movement of the information processing apparatus itself, it is possible to perform operation that corresponds to the orientation of the first housing and does not give a feeling of strangeness, and to display an image that corresponds to the direction of the screen section and does not give a feeling of strangeness.

In another configuration example, the first housing may further include a second screen section for displaying a predetermined image, and the display processing section may perform predetermined display processing for the second display section, based on the first housing orientation data.

According to the above configuration example, it is possible to display, on the screen of the first housing, an image that corresponds to the orientation of the first housing without giving a feeling of strangeness.

In another configuration example, the display processing section may include: a camera setting section for setting a shooting direction of a virtual camera placed in a virtual space; and an image outputting section for outputting an image of the virtual space shot by the virtual camera to each of the first screen section and the second screen section. The camera setting section may set, as a first shooting direction, the shooting direction of the virtual camera corresponding to a direction of the first screen section calculated based on the second housing orientation data, and may set, as a second shooting direction, the shooting direction of the virtual camera corresponding to a direction of the second screen section calculated based on the first housing orientation data. The image outputting section may output, to the first screen section, an image of the virtual space shot in the first shooting direction, and may output, to the second screen section, an image of the virtual space shot in the second shooting direction.

According to the above configuration example, it is possible to display images corresponding to the respective orientations of the housings, on the respective screens of the housings.

In another configuration example, the information processing apparatus may further comprise a gravity direction calculation section for calculating a gravity direction, based on the detected data outputted by the orientation detection section. The display processing section may perform the predetermined display processing, based on the second housing orientation data and the gravity direction.

According to the above configuration example, since an image based on the gravity direction is displayed, the displayed image does not cause a feeling of strangeness.

In another configuration example, the orientation detection section may include an angular velocity sensor, and the gravity direction calculation section may calculate, as the gravity direction, a predetermined direction defined when the first housing is in a predetermined orientation.

According to the above configuration example, it is possible to display an image based on the gravity direction, even if the information processing apparatus includes only the acceleration sensor.

In another configuration example, the orientation detection section may include an acceleration sensor, and the gravity direction calculation section may detect a gravity acceleration in a state in which the first housing is substantially at rest, thereby calculating the gravity direction.

According to the above configuration example, it is possible to calculate the gravity direction more accurately, and to execute image display processing based on the gravity direction more appropriately.

In another configuration example, the orientation detection section may include at least an angular velocity sensor and an acceleration sensor. The detected data may include angular velocity data outputted by the angular velocity sensor. The gravity direction calculation section may calculate the gravity direction, based on an output from the acceleration sensor.

According to the above configuration example, it is possible to calculate an orientation more accurately.

In another configuration example, the orientation detection section may include at least one of an angular velocity sensor and an acceleration sensor.

According to the above configuration example, it is possible to detect the orientation of the first housing more easily and more accurately.

A computer-readable storage medium having stored therein an information processing program according to the present invention is a computer-readable storage medium having stored therein an information processing program that is executed by a computer of an information processing apparatus, which information processing apparatus includes: a first housing including an orientation detection section for detecting an orientation; and a second housing including a first screen section for displaying a predetermined image, the second housing being connected to the first housing such that a relative orientation of the second housing with respect to the first housing can be changed, the information processing program causing the computer to function as: second housing orientation calculation means; and display processing means. The second housing orientation calculation means calculates second housing orientation data indicating the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data. The display processing means performs predetermined display processing for the first screen section, based on the second housing orientation data.

An information processing method according to the present invention is an information processing method used in an information processing apparatus, which information processing apparatus includes: a first housing including an orientation detection section for detecting an orientation; and a second housing including a first screen section for displaying a predetermined image, the second housing being connected to the first housing such that a relative orientation of the second housing with respect to the first housing can be changed, the information processing method comprising: a second housing orientation calculation step; and a display processing step. The second housing orientation calculation step calculates the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data. The display processing step performs predetermined display processing for the first screen section, based on the relative orientation of the second housing or the variation in the relative orientation.

An information processing system according to the present invention comprises; a first housing; a second housing; second housing orientation calculation means; and display processing means. The first housing includes orientation detection means for detecting an orientation. The second housing includes a screen for displaying a predetermined image, the second housing being connected to the first housing such that a relative orientation of the second housing with respect to the first housing can be changed. The second housing orientation calculation means calculates second housing orientation data indicating the relative orientation of the second housing or a variation in the relative orientation, based on a value obtained by adding a predetermined offset to detected data outputted by the orientation detection means, or to first housing orientation data indicating an orientation of the first housing or a variation in the orientation, which orientation is calculated based on the detected data. The display processing means performs predetermined display processing for the first screen section, based on the second housing orientation data.

According to the present invention, an information processing apparatus including two housings only one of which includes the orientation detection section can estimate the orientation of the other one of the two housings, and can perform image display processing using the estimated orientation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in an opened state;

FIG. 2A is a left side view of the game apparatus 10 in a closed state;

FIG. 2B is a front view of the game apparatus 10 in a closed state;

FIG. 2C is a right side view of the game apparatus 10 in a closed state;

FIG. 2D is a rear view of the game apparatus 10 in a closed state;

FIG. 3 is a block diagram showing an internal configuration of the game apparatus 10;

FIG. 4 shows the orientation of a game apparatus as it is when a game assumed in the first embodiment is being played;

FIG. 5 shows a game screen assumed in the first embodiment;

FIG. 6 shows the orientation of the game apparatus as it is when the game assumed in the first embodiment is being played;

FIG. 7 shows the game screen assumed in the first embodiment;

FIG. 8 shows the orientation of the game apparatus as it is when the game assumed in the first embodiment is being played;

FIG. 9 shows the game screen assumed in the first embodiment;

FIG. 10 shows the orientation of the game apparatus as it is when the game assumed in the first embodiment is being played;

FIG. 11 shows the orientation of the game apparatus as it is when the game assumed in the first embodiment is being played;

FIG. 12 shows the orientation of the game apparatus as it is when the game assumed in the first embodiment is being played;

FIG. 13 shows a memory map of a main memory 32 of the game apparatus 10;

FIG. 14 is a flowchart showing game processing according to the first embodiment;

FIG. 15 is a flowchart showing the details of opening angle input screen processing in step S1 shown in FIG. 14;

FIG. 16 is a block diagram showing an internal configuration of a game apparatus 110 according to the second embodiment;

FIG. 17 shows a memory map of a main memory 32 according to the second embodiment;

FIG. 18 is a flowchart showing game processing according to the second embodiment;

FIG. 19 is a schematic diagram showing an example of peripheral equipment according to the third embodiment;

FIG. 20 is a schematic diagram showing an example of the peripheral equipment according to the third embodiment;

FIG. 21 is a schematic diagram showing an example of the peripheral equipment according to the third embodiment;

FIG. 22 is a block diagram showing internal configurations of a game apparatus and the peripheral equipment according to the third embodiment;

FIG. 23 is a schematic diagram showing an example of the peripheral equipment according to the third embodiment; and

FIG. 24 is a schematic diagram showing an example of an attachment.

### DESCRIPTION OF THE PREFERRED EMBODIMENTS

Hereinafter, embodiments of the present invention will be described with reference to the drawings. It is noted that the present invention is not limited by the embodiments.

(First Embodiment)

(Structure of Game Apparatus)

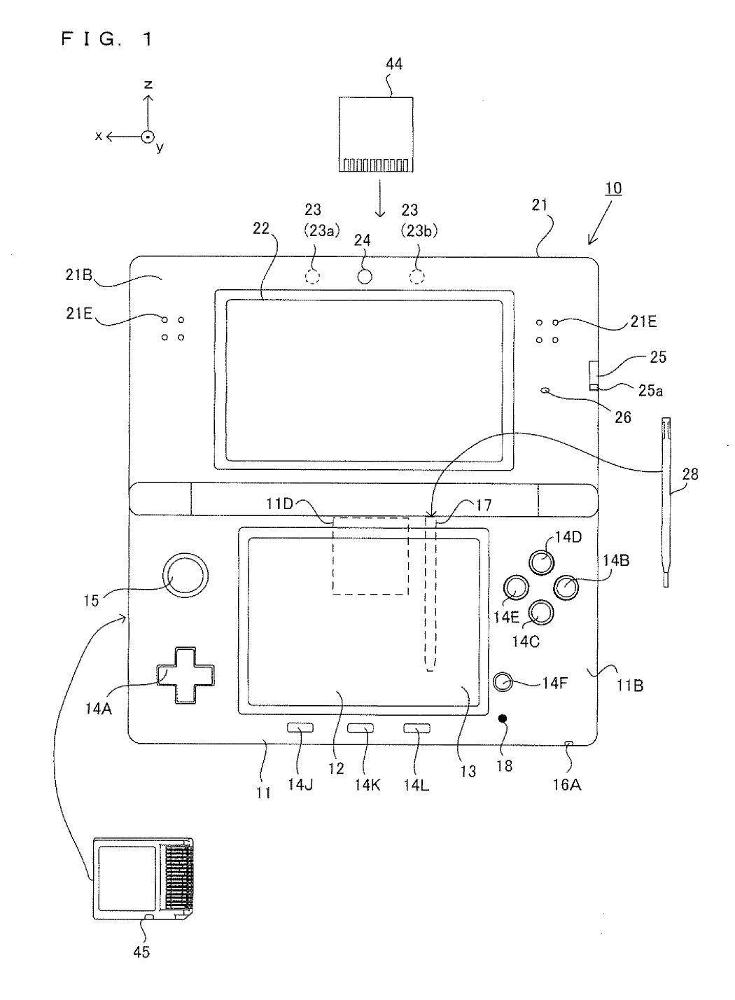

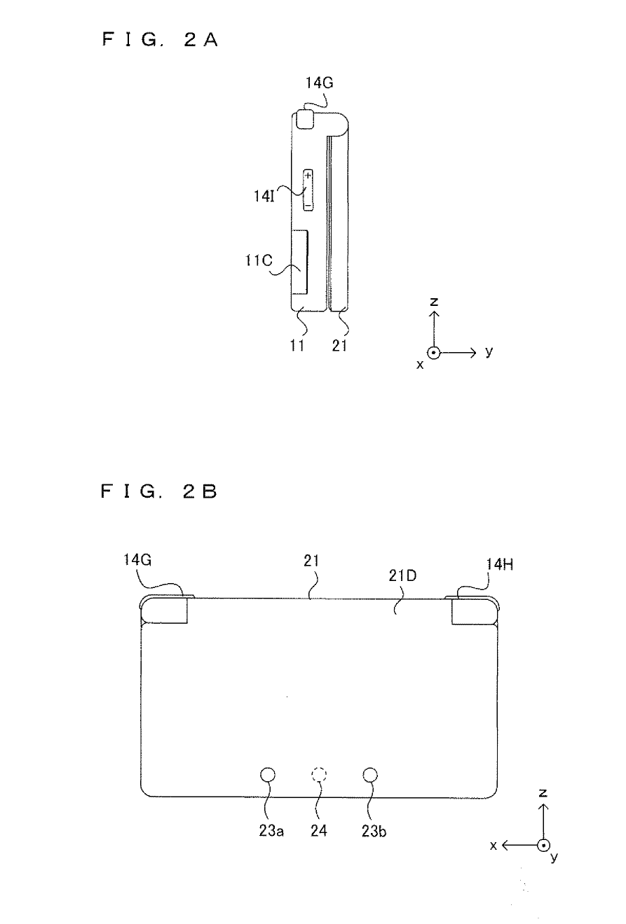

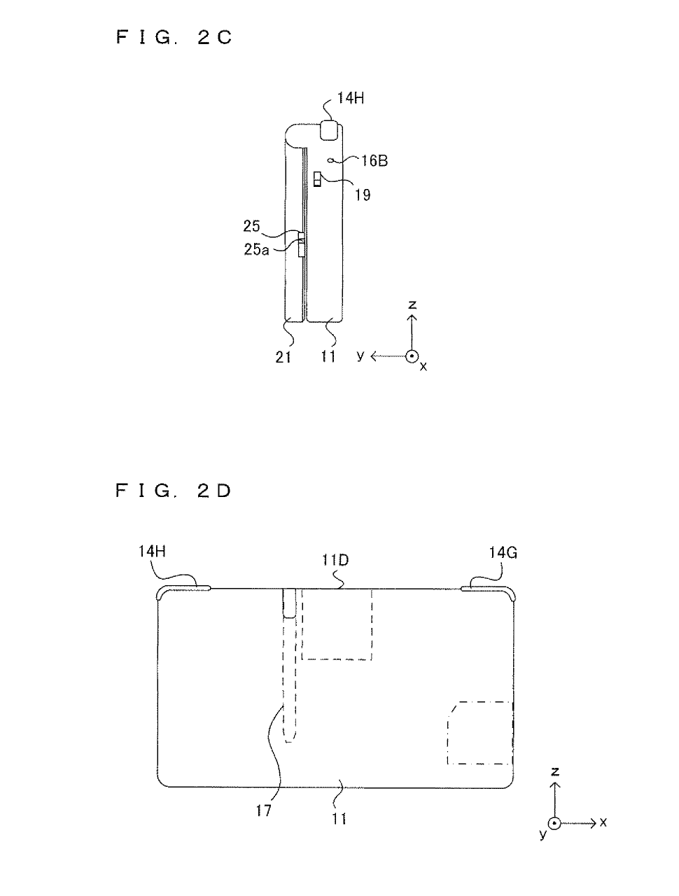

Hereinafter, a game apparatus according to one embodiment of the present invention will be described. A game apparatus 10 is a hand-held game apparatus. The game apparatus 10 includes a lower housing 11 and an upper housing 21 as shown in FIG. 1, and FIG. 2A to FIG. 2D. The lower housing 11 and the upper housing 21 are connected to each other so as to be openable and closable (foldable).

(Description of Lower Housing)

As shown in FIG. 1, and FIG. 2A to FIG. 2D, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided.

The touch panel 13 is mounted on the screen of the lower LCD 12. The insertion opening 17 (indicated by dashed line in FIG. 1 and FIG. 2D) for storing a touch pen 2S is provided on the upper side surface of the lower housing 11.

A cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11.

The analog stick 15 is a device for indicating a direction.

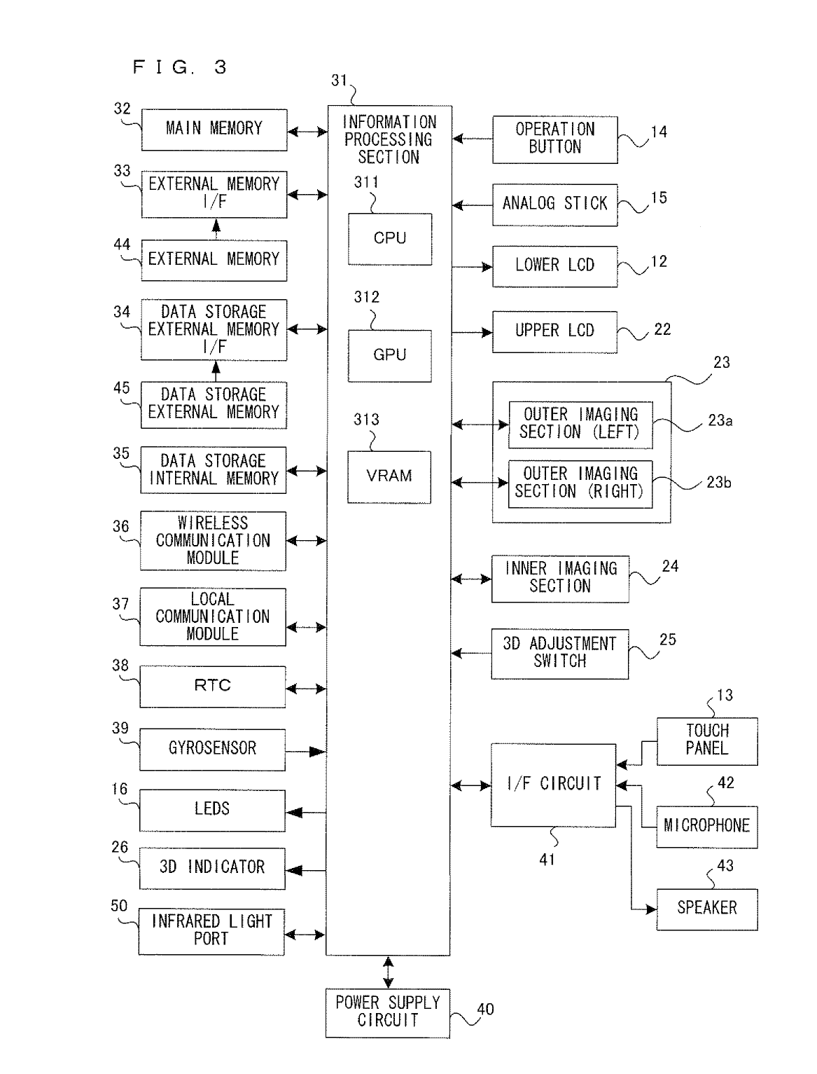

The microphone hole 18 is provided on the inner side surface of the lower housing 11. Under the microphone hole 18, a microphone 42 (see FIG. 3) is provided as a sound input device described below.

As shown in FIG. 2B and FIG. 2D, an L button 14G and an R button 14H are provided on the upper side surface of the lower housing 11 Further, as shown in FIG. 2A, a sound volume button 141 is provided on the left side surface of the lower housing 11. The sound volume button 141 is used for adjusting a sound volume of a speaker 43 (see FIG. 3) of the game apparatus 10.

As shown in FIG. 2A, a cover section 11C is provided on the left side surface of the lower housing 11 so as to be openable and closable. Inside the cover section 11C, a connector is provided for electrically connecting between the game apparatus 10 and an external data storage memory 45.

As shown in FIG. 2D, an insertion opening 11D through which an external memory 44 is inserted is provided on the upper side surface of the lower housing 11.

Further, as shown in FIG. 1 and FIG. 2C, a first LED 16A for notifying a player of an ON/OFF state of a power supply of the game apparatus 10 is provided on the lower side surface of the lower housing 11, and a second LED 16B for notifying a player of an establishment state of a wireless communication of the game apparatus 10 is provided on the right side surface of the lower housing 11. The game apparatus 10 can make wireless communication with other devices. A wireless switch 19 for enabling/disabling the function of the wireless communication is provided on the right side surface of the lower housing 11 (see FIG. 2C).

In addition, although not shown, an infrared light port is provided in the upper side surface of the lower housing 11, thereby enabling infrared communication with a predetermined apparatus. For example, the infrared light port is positioned between the insertion opening 11D and the L button 14G.

(Description of Upper Housing)

As shown in FIG. 1 to FIG. 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided.

The upper LCD 22 is a display device capable of displaying a stereoscopically visible image. Specifically, the upper LCD 22 is a display device capable of displaying an image which is stereoscopically visible with naked eyes. The upper LCD 22 allows the player to view the image for a left eye with her/his left eye, and the image for a right eye with her/his right eye by utilizing a parallax barrier, so that an image (a stereoscopically visible image) exerting a stereoscopic effect for the player can be displayed. Further, the upper LCD 22 may disable the parallax barrier. When the parallax barrier is disabled, an image can be displayed in a planar manner. Thus, the upper LCD 22 is a display device capable of switching between a stereoscopic display mode for displaying a stereoscopically visible image and a planar display mode (for displaying a planar visible image) for displaying an image in a planar manner. The switching of the display mode is performed by, for example, the 3D adjustment switch 25 described later.

Two imaging sections (23a and 23b) provided on the outer side surface 21D of the upper housing 21 are generically referred to as the outer imaging section 23. The outer imaging section (left) 23a and the outer imaging section (right) 23b can be used as a stereo camera depending on a program executed by the game apparatus 10.

The inner imaging section 24 is positioned on the inner side surface 21B of the upper housing 21, and acts as an imaging section which has an imaging direction which is the same direction as the inward normal direction of the inner side surface.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. A slider 25a of the 3D adjustment switch 25 is slidable to any position in a predetermined direction (the height direction), and a display mode of the upper LCD 22 is determined in accordance with the position of the slider 25a. In addition, a manner in which the stereoscopic image is visible is adjusted in accordance with the position of the slider 25a.

The 3D indicator 26 is an LED that indicates whether or not the upper LCD 22 is in the stereoscopic display mode.

In addition, a speaker hole 21E is provided on the inner side surface of the upper housing 21. A sound is outputted through the speaker hole 21E from a speaker 43 described below.

(Internal Configuration of Game Apparatus 10)

Next, an internal electrical configuration of the game apparatus 10 will be described with reference to FIG. 3. As shown in FIG. 3, the game apparatus 10 includes, in addition to the components described above, electronic components such as an information processing section 31, a main memory 32, an external memory interface (external memory PF) 33, an external data storage memory PF 34, an internal data storage memory 35, a wireless communication module 36, a local communication module 37, a real-time clock (RTC) 38, a gyrosensor 39, a power supply circuit 40, an infrared light port 50, an interface circuit (PF circuit) 41, and the like.

The information processing section 31 is information processing means which includes a CPU (Central Processing Unit) 311 for executing a predetermined program, a GPU (Graphics Processing Unit) 312 for performing image processing, VRAM (Video RAM) 313, and the like. The CPU 311 executes a program stored in a memory (for example, the external memory 44 connected to the external memory I/F 33 or the internal data storage memory 35) included in the game apparatus 10, thereby executing processing corresponding to the program. The program executed by the CPU 311 may be acquired from another device through communication with the other device. The GPU 312 generates an image in accordance with an instruction from the CPU 311 of the information processing section 31, and renders the image in the VRAM 313. The image rendered in the VRAM 313 is outputted to the upper LCD 22 and/or the lower LCD 12, and the image is displayed on the upper LCD 22 and/or the lower LCD 12.

The external memory I/F 33 is an interface for detachably connecting to the external memory 44. The external data storage memory I/F 34 is an interface for detachably connecting to the external data storage memory 45. The infrared light port 50 is an interface for performing infrared communication with a predetermined apparatus.

The main memory 32 is a volatile storage apparatus used as a work area and a buffer area for (the CPU 311 of) the information processing section 31.

The external memory 44 is a nonvolatile storage apparatus for storing, for example, a program executed by the information processing section 31. The external memory 44 is implemented as, for example, a read-only semiconductor memory.

The external data storage memory 45 is implemented as a non-volatile readable and writable memory (for example, a NAND flash memory), and is used for storing given data.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, infrared communication).

The gyrosensor 39 detects respective angular velocities with respect to three axes (X-axis, Y-axis, and Z-axis). For example, the gyrosensor 39 includes a chip of gyrosensor for three axes. Specifically, the gyrosensor detects an angular velocity with respect to a yaw angle (an angular velocity around the Y-axis) (per unit time), an angular velocity with respect to a roll angle (an angular velocity around the Z-axis) (per unit time), and an angular velocity with respect to a pitch angle (an angular velocity around the X-axis) (per unit time). It is noted that, in the present specification, the positive direction of the Z-axis of the game apparatus 10 in FIG. 1 is set as a reference direction, and the directions of rotations around the X-axis, the Y-axis, and the Z-axis are referred to as a pitch direction, a yaw direction, and a roll direction, respectively.

The RTC 38 counts time, and outputs the time to the information processing section 31. The information processing section 31 calculates a current time (date) based on the time counted by the RTC 38. The power supply circuit 40 controls power from the power supply (a rechargeable battery) of the game apparatus 10, and supplies power to each component of the game apparatus 10.

The touch panel 13, the microphone 42, and the speaker 43 are connected to the PF circuit 41. The PF circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The information processing section 31 acquires the touch position data, to recognize a position on which an input is made on the touch panel 13.

The operation button 14 includes the operation buttons 14A to 14L described above. Operation data representing an input state of each of the operation buttons 14A to 14I is outputted from the operation button 14 to the information processing section 31, and the input state indicates whether or not each of the operation buttons 14A to 14I has been pressed.

The lower LCD 12 and the upper LCD 22 are connected to the information processing section 31. Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye, which are stored in the VRAM 313 of the information processing section 31 are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. The player views the images through the parallax barrier in the upper LCD 22, so that the image for the right eye is viewed by the player's right eye, and the image for the left eye is viewed by the player's left eye. Thus, the stereoscopically visible image is displayed on the screen of the upper LCD 22.

The outer imaging section 23 and the inner imaging section 24 each take an image in accordance with an instruction from the information processing section 31, and output data of the taken image to the information processing section 31.

The 3D adjustment switch 25 transmits, to the information processing section 31, an electrical signal in accordance with the position of the slider 25a.

The information processing section 31 controls whether or not the 3D indicator 26 is to be lit up. For example, the information processing section 31 lights up the 3D indicator 26 when the upper LCD 22 is in the stereoscopic display mode.

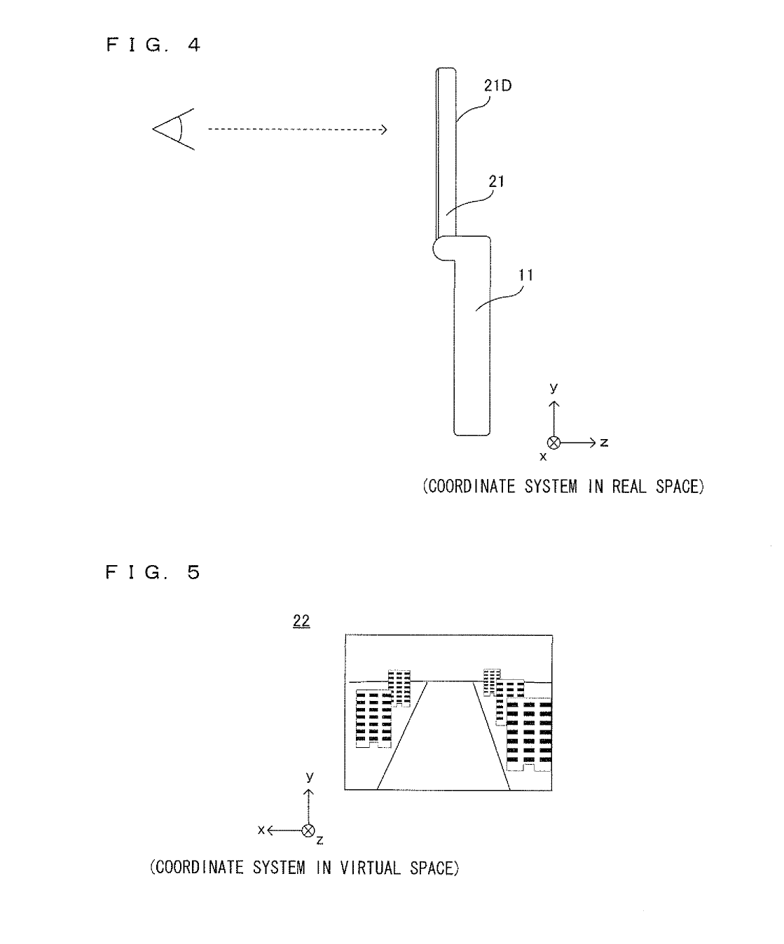

Next, with reference to FIG. 4 to FIG. 12, an outline of game processing assumed in the first embodiment will be described. In the game assumed in the first embodiment, a player character freely moves in a virtual 3-dimensional space (hereinafter, simply referred to as a virtual space). For example, the game includes a so-called FPS (first person shooting) or a so-called flight simulator. In the game, an image of a virtual space shot by a virtual camera is displayed as a game image on the upper LCD 22, and an image of a button for operation, and information (for example, a map image) useful for progressing the game are mainly displayed on the lower LCD 12.

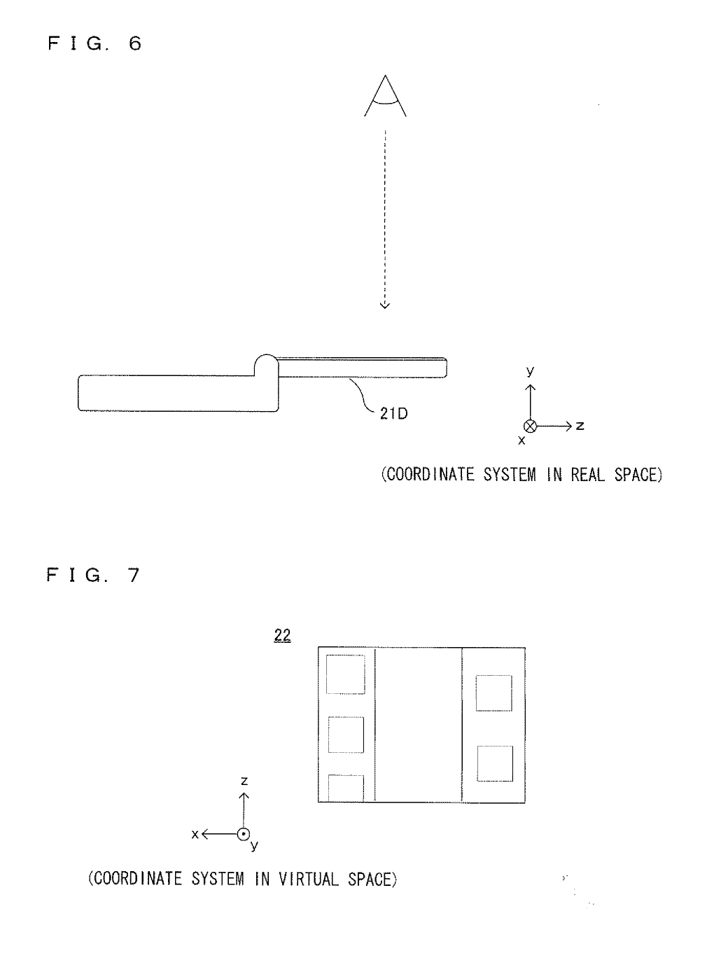

In addition, in the game processing assumed in the present embodiment, the direction of the virtual camera is associated with the direction (orientation) of the game apparatus 10 (that is, a viewpoint can be changed by moving the game apparatus 10 itself). Typically, it is assumed that the game is played in the state in which an opening angle between the upper housing 21 and the lower housing 11 of the game apparatus 10 is 180 degrees (hereinafter, referred to as a 180-degree open state). In this state, when the game apparatus 10 faces in the forward direction of the player (which is the positive direction of the Z-axis in FIG. 4) in the real space as shown in FIG. 4, an image of the virtual space shot in a direction corresponding to the forward direction from the viewpoint of the player (that is, an image shot in the depth direction, which is the Z-axis direction in FIG. 5, from the virtual camera position) is displayed as a game image, as shown in FIG. 5, On the other hand, for example, when the outer side surface 21D of the upper housing 21 and the outer side surface of the lower housing 11 of the game apparatus 10 face downward (in the negative direction of the Y-axis in the real space) in the real space as shown in FIG. 6, also the virtual camera faces downward in the virtual space, and an image of the virtual space shot in the downward direction by the virtual camera (image of the virtual space as it is looked down upon) is displayed on the upper LCD 22 as shown in FIG. 7.

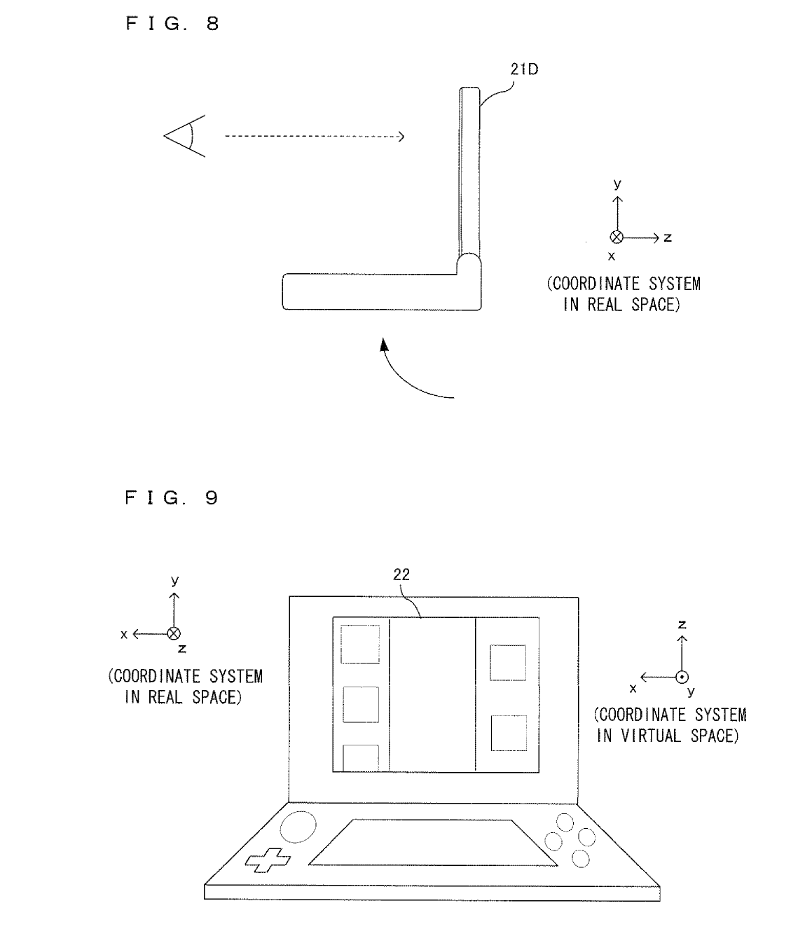

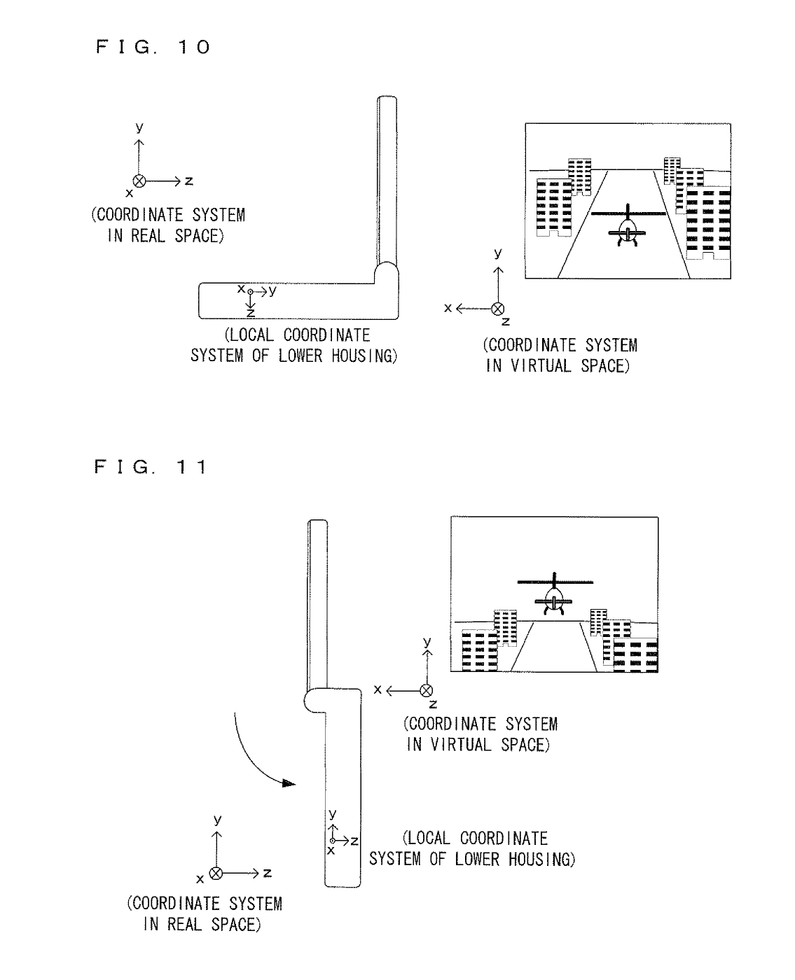

Here, as described above, the gyrosensor 39 is included in the lower housing 11 of the game apparatus 10. Therefore, the direction (orientation) of the lower housing 11 can be calculated based on an output from the gyrosensor 39. On the other hand, a gyrosensor is not included in the upper housing 21. Therefore, in the case where the direction of the virtual camera is associated with the direction of the game apparatus 10 as described above, the direction of the virtual camera may be changed in accordance with the direction (orientation) of the lower housing 11. In this case, on the assumption that the opening degree is fixed and that, for example, the game is played in the 180-degree state as described above, if the game is designed and developed such that the direction of the virtual camera is associated with the direction of the game apparatus 10, it is possible to display a game image intended by a developer as long as the game is played in the 180-degree open state. On the other hand, in the case where the opening angle is changed while the game is played, it is assumed that, for example, the game is played in the 180-degree open state as shown in FIG. 4 at the beginning and then the lower housing 11 is turned up by the player as shown in FIG. 8 while the game is played, whereby the opening angle is changed to 90 degrees. In this case, if the direction of the virtual camera is controlled based on the direction of the lower housing 11, the direction of the virtual camera is changed to the downward direction since the outer side surface of the lower housing 11 faces downward. As a result, even though the outer surface 21D of the upper housing faces in the forward direction of the player, an image of the virtual space shot from above is displayed as a game image as shown in FIG. 9, which image should be displayed when the outer surface 21D of the upper housing faces downward. As a result, an image intended by the developer is not displayed (a coordinate system of the real space and a coordinate system of the virtual space are rotated relative to each other by an angle of 90 degrees).

Accordingly, in the first embodiment, an offset value corresponding to the opening angle is applied to the direction (orientation) of the lower housing 11, thereby estimating the direction (orientation) of the upper housing 21, and the direction (shooting direction) of the virtual camera is controlled based on the estimated direction of the upper housing 21. That is, by an offset value being applied to the orientation of the lower housing calculated based on an output from the gyrosensor 39, processing is performed as if a gyrosensor were included in the upper housing 21. Specifically, in the first embodiment, by the player inputting information indicating the opening angle, the offset value corresponding to the opening angle is set. Then, the offset value is added to an output value (angular velocity data) from the gyrosensor 39, thereby calculating the direction of the upper housing 21, and the like. For example, in the game apparatus 10, a connection portion (hereinafter, referred to as a hinge portion) between the housings are configured as appropriate such that the opening angle is fixed at any one of 90 degrees, 135 degrees, and 180 degrees. Then, a screen for selecting the opening angle from among 90 degrees, 135 degrees, and 180 degrees is displayed before the game is started, to have the player select it. The game processing is started based on the offset value corresponding to the selected angle. If the player changes the opening angle while the player plays the game, the player inputs information indicating the change each time, thereby setting the offset value again. For example, while the player plays the game, by the player pressing the start button 14L, an opening angle selection screen may be displayed to allow the player to select the opening angle.

In this manner, in the first embodiment, the direction (orientation) of the upper housing 21 is estimated based on the offset value (opening angle information inputted by the player) and an output from the gyrosensor. The virtual camera is controlled in accordance with the direction of the upper housing 21. Since the upper housing 21 has a screen on which an image shot by the virtual camera is to be displayed, the direction (orientation) of the upper housing 21 and the direction (orientation) of the virtual camera are made to coincide with each other, thereby enabling intuitive operation of changing the viewpoint.

In addition, the cost of hardware can be reduced by using the offset value described above, in comparison with the case where a gyrosensor is provided in the upper housing 21. In addition, if the gyrosensors 39 are provided in both the upper housing and the lower housing, operation processing of calculating orientations needs to be performed on each of the upper housing and the lower housing. However, if the offset value is used as in the present embodiment, the load of processing is reduced in comparison with the case where the operation processing of calculating two orientations is performed.

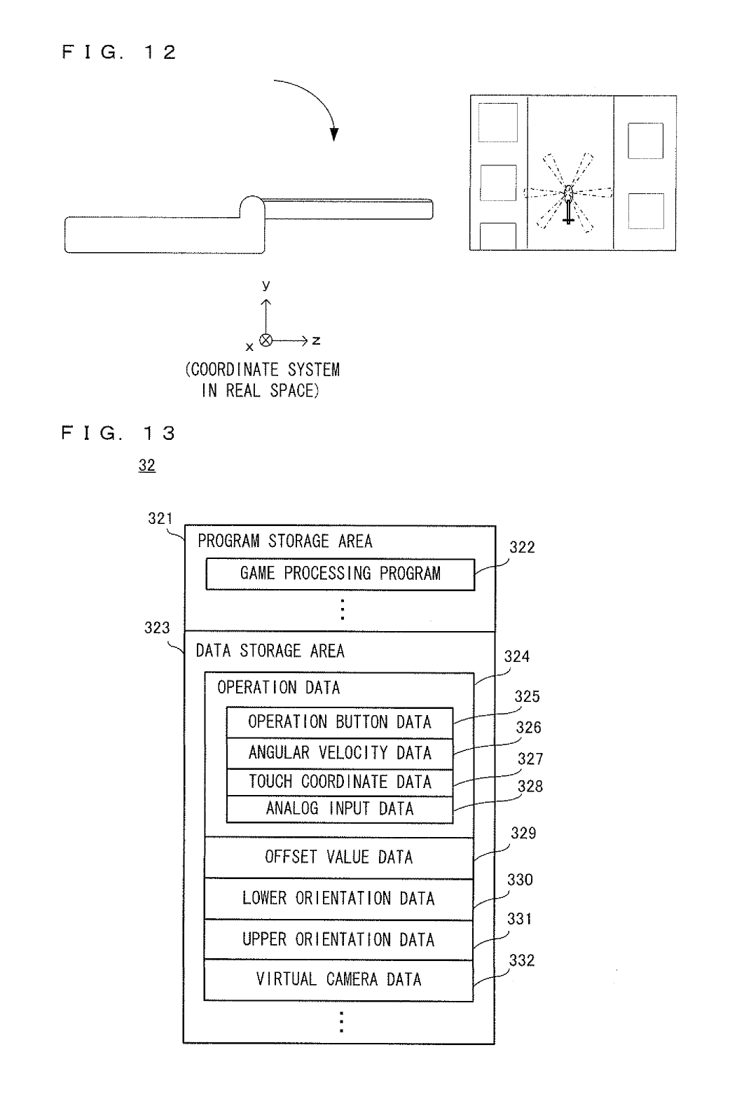

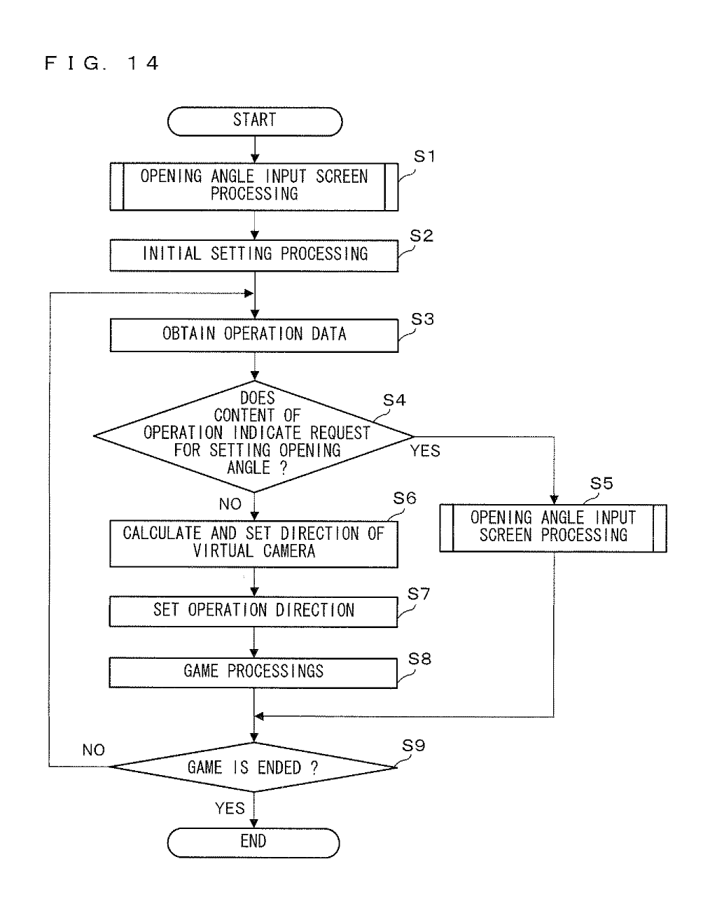

In addition, in the game processing of the first embodiment, processing of controlling the direction of operation is also performed besides processing of controlling the virtual camera described above. For example, a flight game of driving a helicopter object (hereinafter, simply referred to as a helicopter) in a virtual space is assumed. A game image is displayed with the viewpoint set in the back, in an initial state just after the game is started. That is, the game image indicates a view seen when the helicopter is looked at from the back. Under the condition that the above game image is displayed, it is assumed that the game apparatus 10 is in the state where the opening angle is at 90 degrees (hereinafter, referred to as a 90-degree open state) as shown in FIG. 10, for example. In this state, if the upward direction of the analog stick 15 is inputted, the helicopter moves forward (in the travelling direction, the positive direction of the Z-axis in the virtual space). Thereafter, in the case where the lower housing 11 is turned downward to set the game apparatus 10 in the 180-degree open state (see FIG. 11), when the player inputs the opening angle that has been changed, as described above, and then inputs the upward direction of the analog stick 15, the helicopter rises (moves in the positive direction of the Y-axis in the virtual space). That is, the correspondence relationship between the direction (orientation) of the analog stick in the real space and the direction of movement in the virtual space changes by an angle of 90 degrees as a result of the change from the 90-degree open state to the 180-degree open state.

Next, from the state shown in FIG. 11, it is assumed that the upper housing 21 is inclined forward (in the positive direction of the Z-axis) to set the game apparatus 10 in the 180-degree open state (see FIG. 12). In this case, an image of the virtual space as it is looked down upon from above is displayed on the upper LCD 22 as shown in FIG. 7. If the upward direction of the analog stick 15 is inputted, the helicopter moves forward (in the positive direction of the Z-axis) in the virtual space (the game image is scrolled in the height direction of the screen). That is, when the orientation of the upper housing has changed without the orientation of the lower housing changing, the correspondence relationship between the direction (orientation) of the analog stick and the direction of movement does not change.

That is, by giving information about the opening angle to the direction of the virtual camera, by what degree the analog stick 15 is inclined relative to the upper LCD 22 can be calculated, and in addition, a direction in the virtual space corresponding to the direction of the analog stick 15 can be calculated. In other words, relative information indicating the inclination of the analog stick 15 relative to the upper LCD 22 is applied to the absolute direction of the screen (upper LCD 22), whereby the absolute direction of the analog stick 15 in the virtual space can be determined.

In this manner, in the first embodiment, the direction of the upper housing 21 relative to the direction of the lower housing 11 (that is, the opening angle) is designated as the offset value, whereby game control in which the orientation of the upper housing 21 is reflected can be performed without providing a gyrosensor in the upper housing 21.

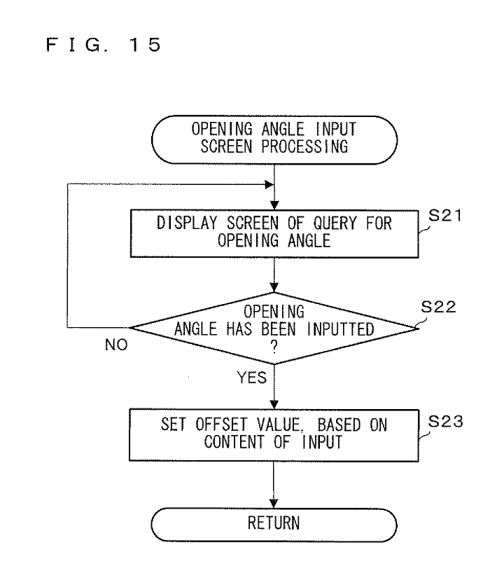

Next, the details of the game processing of the first embodiment, which is executed by the game apparatus 10, will be described. First, data to be stored in the main memory 32 in the game processing will be described. FIG. 13 shows a memory map of the main memory 32 of the game apparatus 10. With reference to FIG. 13, the main memory 32 includes a program storage area 321 and a data storage area 323. Data to be stored in the program storage area 321 and the data storage area 323 is stored in the external memory 44 or the data storage internal memory 35. The data is transmitted to the main memory 32 and stored in the main memory, when a game program is executed.

The program storage area 321 stores a game program to be executed by the CPU 311. The game program includes a game processing program 322 and the like.

The data storage area 323 stores operation data 324, offset value data 329, lower orientation data 330, upper orientation data 331, virtual camera data 332, and the like.

The operation data 324 indicates the content of an operation of the game apparatus 1 performed by the player. The operation data 324 includes operation button data 325 that indicates the pressing states of the operation buttons 14, angular velocity data 326 that indicates angular velocities of the respective three axes detected by the gyrosensor 39, touch coordinate data 327 that indicates touch coordinates detected by the touch panel 13, and analog input data 328 that indicates the input state of the analog stick 15.

The offset value data 329 indicates a value corresponding to the opening angle described above.

The lower orientation data 330 indicates the orientation of the lower housing 11 which is calculated based on the angular velocity data 326.

The upper orientation data 331 indicates the orientation of the upper housing 21 which is calculated based on the angular velocity data 326 and the offset value data 329.

The virtual camera data 332 indicates the position, the direction, the angle of view, and the like of a virtual camera placed in a virtual space.

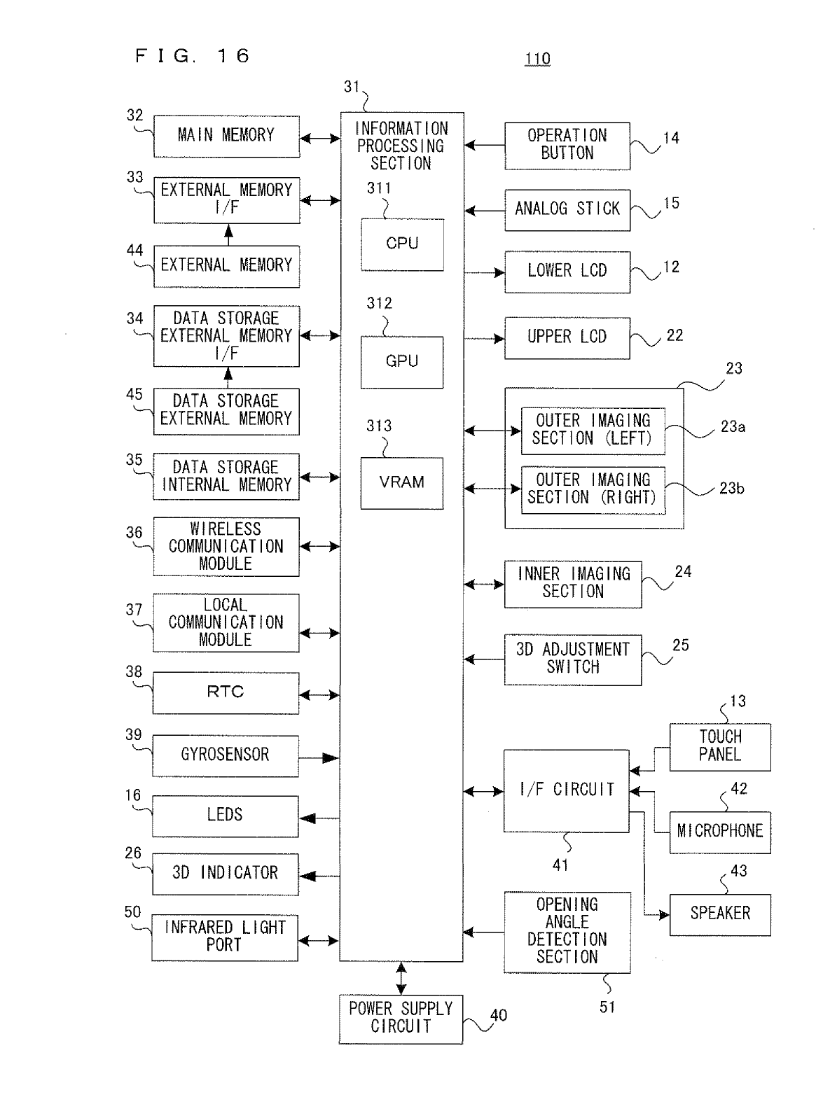

Next, with reference to FIG. 14 to FIG. 15, the game processing executed by the game apparatus 10 will be described. It is noted that FIG. 14 is a flowchart showing the entirety of the game processing executed by the game apparatus 10.

First, in step S1, opening angle input screen processing for querying the player for the opening angle and having the player input the opening angle, is executed. FIG. 15 is a flowchart showing the details of the opening angle input screen processing. With reference to FIG. 15, first, in step S21, a screen for querying the player for the opening angle is generated, and is displayed on the upper LCD 22 (or may be displayed on the lower LCD 12). The screen includes three options of “90 degrees”, “135 degrees”, and “180 degrees”, for example. Next, in step S22, an input from the player is received. That is, whether or not an input has been given to the screen for the query in step S21 is determined. If an input has not been given (NO in step S22), processing returns to step S21, and if an input has been given (YES in step S22), processing proceeds to step S23. For example, if the player has selected an angle corresponding to the actual opening angle of the game apparatus 10 from the three options, it is determined that an input of the opening angle has been given, in step S22.

If the input from the player has been given, next, in step S23, the offset value data 329 is set based on the input. For example, values corresponding to the respective opening angles displayed as the options are stored in advance in the main memory 32, and a value corresponding to the selected opening angle is selected from the values, whereby the offset value data 329 is set at the selected value. Alternatively, the opening angle may be subjected to a predetermined operation, thereby calculating the offset value data 329. Thereafter, the screen for the query is eliminated, and the opening angle input screen processing is ended.

With reference to FIG. 14, next, in step 82, initialization processing for data (except the offset value data 329) to be used in the subsequent steps of processing is executed. In addition, the orientation of the lower housing 11 at this point of time is calculated, and data indicating the orientation is stored as reference orientation data (not shown). The reference orientation data is used as appropriate for calculating the orientation of the lower housing in the subsequent steps of processing. In addition, a virtual game space is configured and displayed on the upper LCD 22. The CPU 311 configures a 3-dimensional virtual game space, and places various objects such as a player object and a geographical object. A game image indicating the game space configured in this manner is generated, and the generated game image is displayed on the monitor 2. Thereafter, the game progresses while a processing loop of steps S3 to S9 (except step S5) is repeated every frame.

Next, in step S3, the operation data 324 is obtained. Next, in step S4, whether or not the operation data 324 indicates an operation of request for setting the opening angle is determined. For example, if a screen for setting the opening angle is displayed by pressing the start button 14L while the game is played, whether or not the start button 14L has been pressed is determined by referring to the operation data 324. As a result of the determination, if the operation data 324 indicates an operation of request for setting the opening angle (YES in step S4), the opening angle input screen processing described above is executed in step S5. The description of this processing is omitted because it is the same as the processing of step S1. After step S5, processing proceeds to step S9 described later.

On the other hand, as a result of the determination in step S4, if the operation data 324 does not indicate an operation of request for setting the opening angle (NO in step S4), the direction of the virtual camera is calculated and the calculated direction is set as the virtual camera data 332, in step S6. More specifically, in step S6, first, the offset value data 329 is added to the angular velocity data 326 (about each of the 3 axes), thereby calculating offset angular velocity data. Then, angles of the respective axes are calculated based on the offset angular velocity data. Moreover, the orientation (which is, for example, represented by a vector indicating the orientations of the respective axes) of the upper housing 21 is calculated based on the angles of the respective axes, and is stored as the upper orientation data 331. If the orientation of the upper housing 21 has been calculated, the direction of the outer side surface of the upper housing 21 (the direction of the upper LCD 22) is also figured out. Then, the direction of the virtual camera is calculated such that the direction of the outer side surface of the upper housing 21 coincides with the shooting direction of the virtual camera. The calculated direction of the virtual camera is stored in the virtual camera data 332.

It is noted that in step S6, instead of a method of applying an offset to the angular velocity data 329 as described above, the orientation of the lower housing 11 may be calculated based on the angular velocity data 326 in the first place, and the offset may be applied to the orientation of the lower housing 11, thereby calculating the orientation of the upper housing 21. In view of processing load, the method of applying an offset to the angular velocity data 326 is more advantageous because the method needs a less amount of calculation. In implementation, appropriate one of the above two methods may be used in accordance with the content of information processing to be executed. In addition, after the orientation of the lower housing 11 is calculated, a variation in the orientation of the lower housing 11 may be calculated and the offset may be added to the variation in the orientation, thereby calculating a variation in the orientation of the upper housing 21.

Next, in step S7, the direction of operation is set. Specifically, first, the orientation of the lower housing 11 is calculated based on the angular velocity data 326, and is stored as the lower orientation data 330. Then, in accordance with the orientation, an inputted direction of the analog stick 15 is associated with the direction of a movement of the player object in the virtual space. For example, if the orientation of the lower housing 11 is parallel to the surface of the ground, an input of the upward direction of the analog stick 15 is associated with a movement (progression) of the player object (for example, the helicopter in FIG. 10 or the like) in the positive direction of the Z-axis (forward direction) in the virtual space. In addition, for example, if the orientation of the lower housing 11 is perpendicular to the surface of the ground, an input of the upward direction of the analog stick 15 is associated with a movement (rising) of the player object in the positive direction of the Y-axis (upward direction) in the virtual space.

Next, in step S8, other various game processings are executed. For example, processings such as a movement of the player object based on the analog input data 328, movements of other various objects, and a determination of collision are executed as appropriate. Then, an image of the virtual space in which the result of the processings have been reflected is shot by the virtual camera, and the image is displayed on the upper LCD 22.

Next, in step S9, whether or not a condition of ending the game has been satisfied is determined. If the condition of ending the game has not been satisfied (NO in step S9), the processing from step S3 is executed again. If the condition of ending the game has been satisfied (YES in step S9), the game processing is ended. The game processing according to the first embodiment is as described above.

As described above, in the first embodiment, the player inputs information indicating the opening angle, and the offset value is set based on the inputted information. Then, the offset value is added to an output from the gyrosensor 39 of the lower housing 11, to estimate the orientation of the upper housing 21, and the estimated orientation is used in the game processing. Thus, it becomes possible to execute the game processing based on the orientation of the upper housing without providing a gyrosensor or the like in the upper housing 21.

(Second Embodiment)

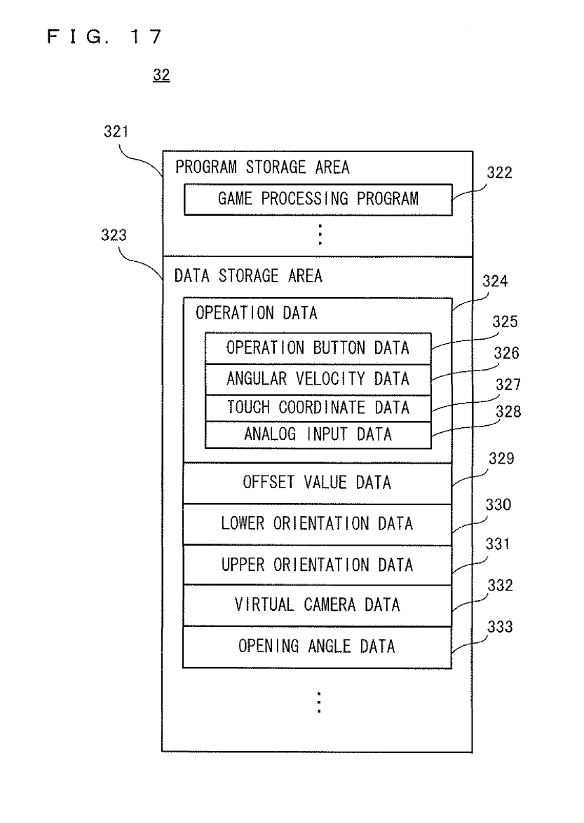

Next, with reference to FIG. 16 to FIG. 18, a second embodiment of the present invention will be described. In the first embodiment, the information indicating the opening angle is inputted by the player. On the other hand, in the second embodiment, a mechanism for detecting the opening angle is provided, as hardware, in a game apparatus. It is noted that except some modifications, the configuration of a game apparatus according to the present embodiment is almost the same as that of the first embodiment. Therefore, the same components as in the first embodiment are denoted by the same reference numerals, and the detailed description thereof is omitted.

FIG. 16 is a diagram (block diagram/hardware configuration diagram) showing the configuration of a game apparatus 110 according to the second embodiment of the present invention. With reference to FIG. 16, the game apparatus 110 includes an opening angle detection section 51 connected to the information processing section 31, in addition to the components of the first embodiment.

The opening angle detection section 51 is a detection switch, of a rotary type, for detecting an angle, and is directly embedded in the connection portion, that is, the hinge portion, between the upper housing 21 and the lower housing 11, for example. For example, a hinge portion of the opening angle detection section 51 is rotated along with the rotation of the hinge portion of the game apparatus, and a movable contact section in the opening angle detection section 51 is rotated in synchronization with the rotation of the hinge portion. The movable contact section comes into contact with a fixed terminal at a set angle, and the fixed terminal is turned on/off, thereby detecting the angle of the rotation. Based on the angle of the rotation, the opening angle is calculated. The calculated opening angle is stored as opening angle data 333 described later. It is noted that the opening angle detection section 51 is not limited to a detection switch of a rotary type, and any device may be used as long as the opening angle can be detected.

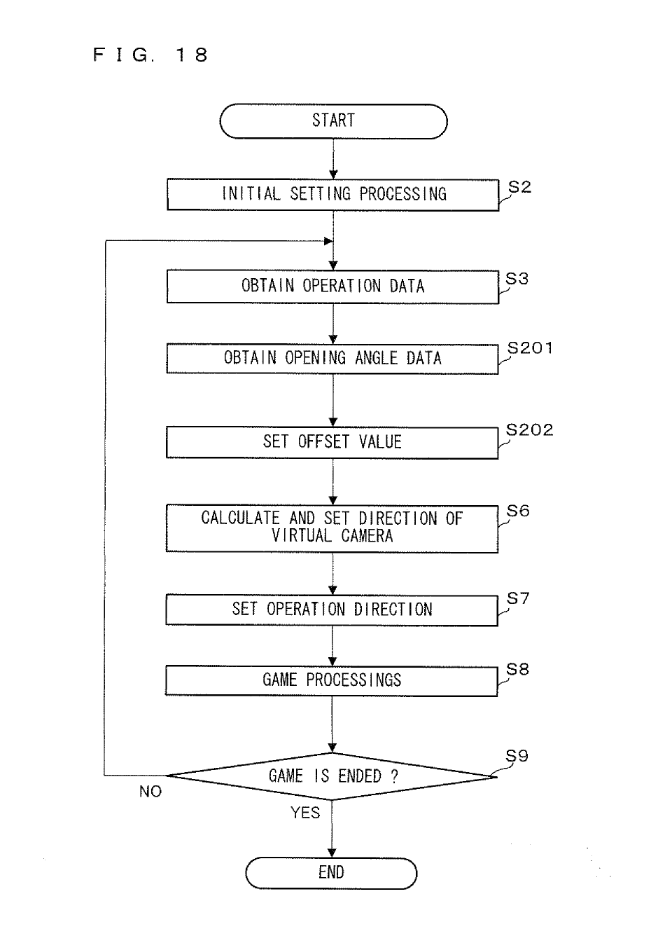

Next, the details of the game processing of the second embodiment will be described. First, data to be stored in the main memory 32 in the game processing of the second embodiment will be described. FIG. 17 shows a memory map of the main memory 32 according to the second embodiment. With reference to FIG. 17, in addition to the data described above with reference to FIG. 13 in the first embodiment, the opening angle data 333 is stored in the data storage area 323 of the main memory 32.

Data outputted from the opening angle detection section 51 is stored as the opening angle data 333. The opening angle data 333 indicates the opening angle between the upper housing 21 and the lower housing 11. In the present embodiment, the opening angle data 333 is updated every time the opening angle detection section 51 detects a variation in the opening angle. That is, only the latest opening angle data (that has been obtained last) is stored as the opening angle data 333.

Next, the game processing executed in the second embodiment will be described. FIG. 18 is a flowchart showing the entirety of the game processing according to the second embodiment. It is noted that in the flowchart, the same steps as in the flowchart shown in FIG. 14 in the first embodiment are denoted by the reference numerals. Specifically, steps S2, S3, and S6 to S9 in the second embodiment are the same as those in the first embodiment.

With reference to FIG. 18, first, data is initialized, and a game image at the beginning of the game is generated and displayed, in initialization processing of step S2. Then, in step 53, operation data is obtained. Next, in step S201, the opening angle data 333 is obtained.

Next, in step S202, the offset value data 329 is set based on the obtained opening angle data. In this step, offset values corresponding to angles indicated by the opening angle data 333 may be prepared in advance, and one of them may be selected to be set as the offset value data 329. Alternatively, an opening angle indicated by the opening angle data 333 may be subjected to a predetermined operation, thereby calculating the offset value data 329. That is, any method may be used as long as an offset value corresponding to the opening angle indicated by the opening angle data 333 can be calculated and set.

It is noted that in step S202, the offset value data 329 may be set only when the opening angle has varied.

Thereafter, the same processing as the processing of steps S6 to S9 of the first embodiment is executed, thereby executing the game processing. The detailed description thereof is omitted.

As described above, in the second embodiment, the opening angle detection section 51 is provided in the game apparatus 10, whereby the opening angle can be detected without having the player input the opening angle. Then, the offset value is set in accordance with the detected opening angle, the orientation of the upper housing 21 is estimated in the same manner as in the first embodiment, and the orientation is used in the game processing. In general, the cost of the opening angle detection section 51 is smaller than that of a gyrosensor. The cost of hardware can be reduced in comparison with the case where a gyrosensor is provided in the upper housing 21. In addition, in view of the amount of processing by software, the operation processing of adding the offset value is more advantageous in comparison with processing of calculating respective orientations by using two gyrosensors.

(Third Embodiment)

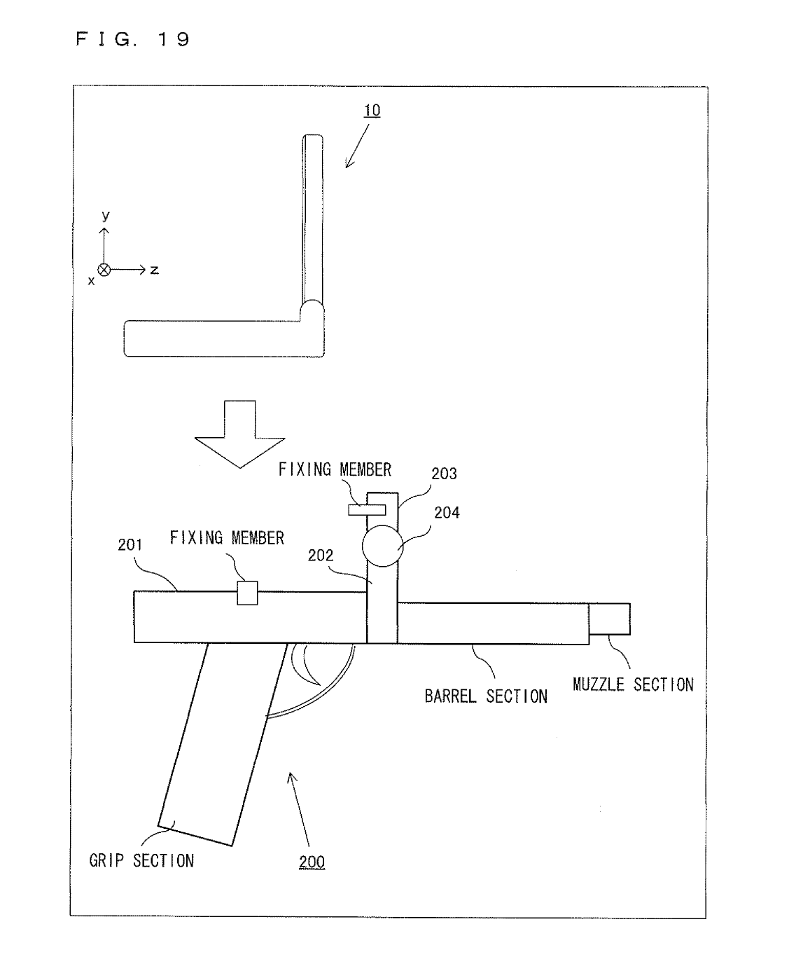

Next, with reference to FIG. 19 to FIG. 23, a third embodiment of the present invention will be described. In the second embodiment, the opening angle detection section 51 for detecting information indicating the opening angle is provided in the game apparatus 110. On the other hand, in the third embodiment, an opening angle detection section is not provided in the game apparatus, but peripheral equipment, of the game apparatus, including an opening angle detection section is used. In other words, peripheral equipment including an opening angle detection section is connected to the game apparatus 10 of the first embodiment, thereby enabling the same game processing as in the second embodiment.

It is noted that a game apparatus 10 according to the third embodiment is the same as that of the first embodiment. Therefore, the same components as in the first embodiment are denoted by the same reference numerals, and the detailed description thereof is omitted.

FIG. 19 is a schematic diagram of a gun-type attachment 200, which is an example of the peripheral equipment according to the third embodiment. With reference to FIG. 19, the gun-type attachment 200 is an attachment representing a gun. In addition, the gun-type attachment 200 includes a lower outer-side-surface attachment section 201, a lower upper-side-surface attachment section 202, and an upper outer-side-surface attachment section 203, on which the game apparatus 10 is attached or detached. In addition, the lower upper-side-surface attachment section 202 and the upper outer-side-surface attachment section 203 are connected via a hinge portion 204 so as to be able to turn relative to each other. An opening angle detection section as described in the second embodiment is provided in the hinge portion 204.

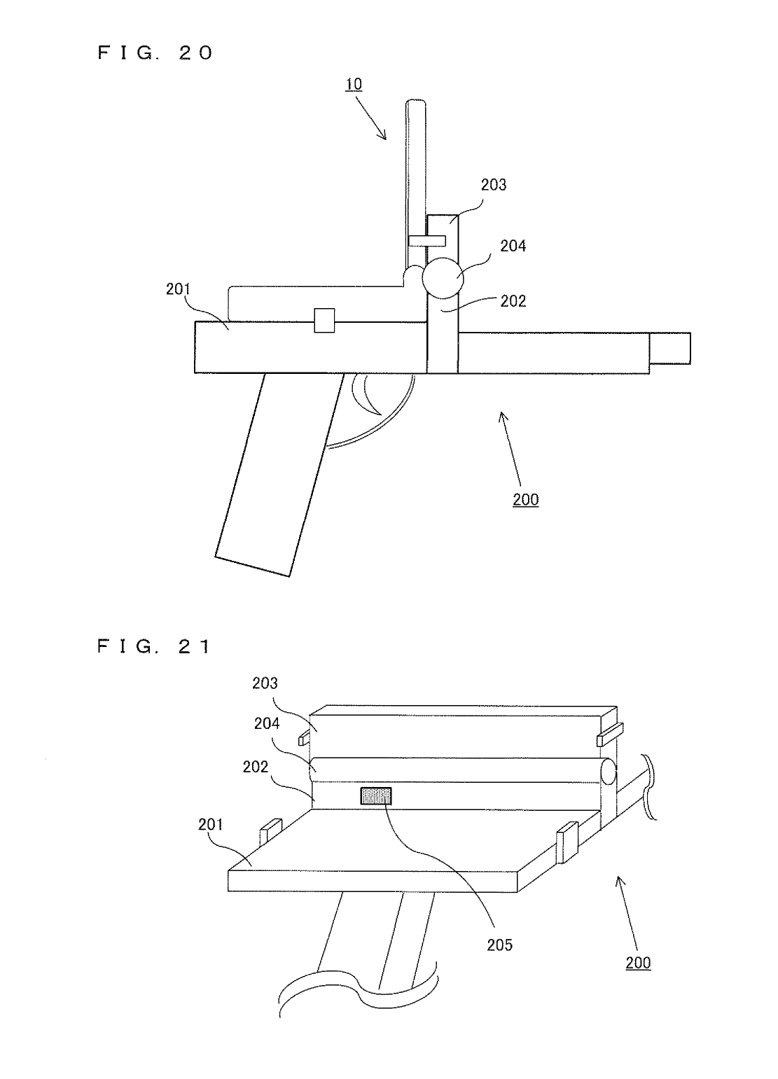

In the present embodiment, as shown in FIG. 20, the game apparatus 10 is attached to the gun-type attachment 200 such that the outer side surface of the lower housing 11 of the game apparatus 10 is in close contact with the lower outer-side-surface attachment section 201 of the gun-type attachment 200, the upper side surface of the lower housing 11 is in close contact with the lower upper-side-surface attachment section 202, and the outer side surface 21D of the upper housing 21 is in close contact with the upper outer-side-surface attachment section 203. Then, in the state in which the game apparatus 10 is attached to the gun-type attachment 200 in this manner, for example, the player moves the game apparatus 10 itself while viewing an image displayed on the upper LCD 22, to take a sight. In this way, the player can play a game using the gun-type attachment 200 to which the game apparatus 10 is attached, like a real gun. A game image obtained by, for example, superimposing a predetermined image onto an image shot by the outer imaging section 23 is displayed on the upper LCD 22.

In addition, an infrared light port 205 is provided in the lower upper-side-surface attachment section 202 as shown in FIG. 21. The infrared light port 205 is provided so as to face the infrared light port 50 provided in the upper side surface of the lower housing 11 of the game apparatus 10 when the game apparatus 10 is attached. The opening angle detection section of the hinge portion 204 outputs data indicating the detected opening angle via the infrared light port 205. The infrared light port 205, and the infrared light port 50 of the game apparatus 10 perform infrared communication with each other, whereby the data is inputted to the game apparatus 10. Thus, the game apparatus 10 can recognize the opening angle between the upper housing 21 and the lower housing 11.

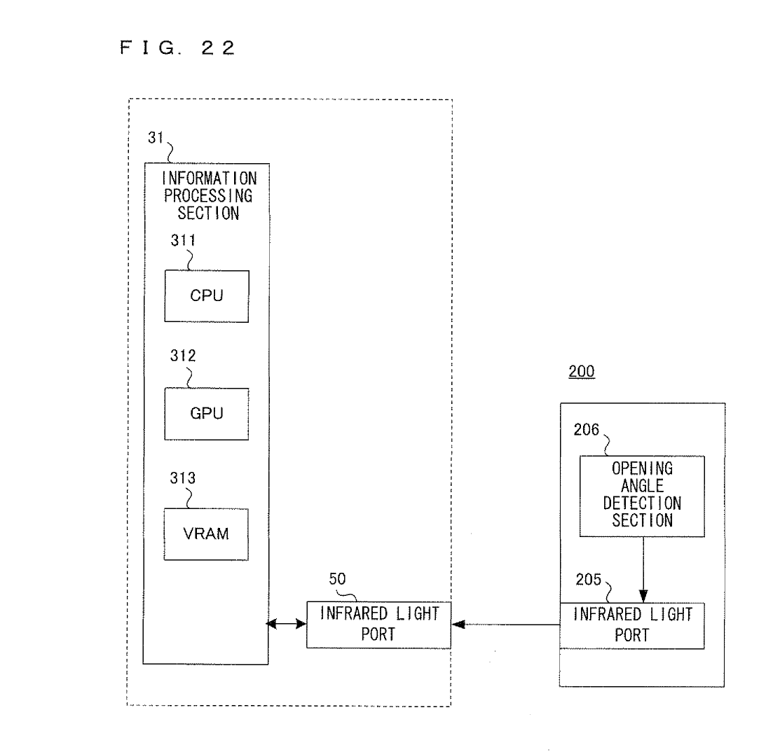

FIG. 22 is a schematic diagram showing an electrical configuration of the inside of the game apparatus 10 according to the third embodiment. It is noted that only components that relate to detection of the opening angle are shown in the drawing, and the other components are not shown. With reference to FIG. 22, the gun-type attachment 200 includes an opening angle detection section 206 and the infrared light port 205. The opening angle detection section 206 outputs data indicating the detected opening angle to the infrared light port 205. The infrared light port 205 performs infrared communication with the infrared light port 50 of the game apparatus 10. The opening angle detection section 206 is electrically connected to the infrared light port 205, and can transmit the detected opening angle to the game apparatus 10 via the infrared light port 205 as described above.

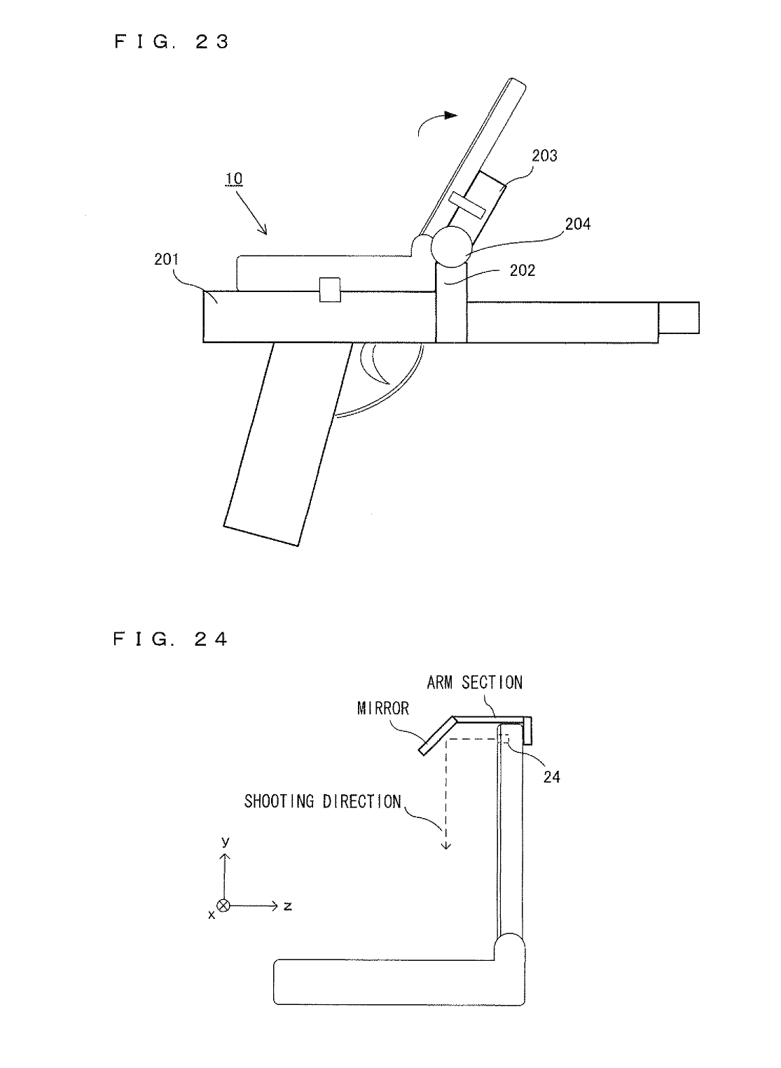

In the above configuration, for example, as shown in FIG. 23, if the upper housing 21 is inclined toward a muzzle, the upper outer-side-surface attachment section 203 which is in close contact with the upper housing 21 moves in conjunction with the upper housing 21. Along with this, the opening angle detection section 206 of the hinge portion 204 detects the opening angle, and outputs data indicating the opening angle to the infrared light port 205. The data is inputted to the infrared light port 50 of the game apparatus 10, and is stored as the opening angle data 333, in the main memory 32. In this way, the game apparatus 10 can recognize the opening angle between the upper housing 21 and the lower housing 11. As a result, the same processing as in the second embodiment can be realized. It is noted that since the details of the processing are the same as in the processing shown in FIG. 18 in the second embodiment, the description thereof is omitted here.

As described above, in the third embodiment, a mechanism for detecting the opening angle is realized, as hardware, by peripheral equipment that can be connected to the game apparatus 10. Therefore, it is possible to perform the same processing as that described in the second embodiment by using the game apparatus 10 having the hardware configuration described in the first embodiment, without modifying the hardware configuration of the game apparatus 10.

It is noted that, instead of the above method, the following methods may be used for detecting the opening angle between the upper housing 21 and the lower housing 11. For example, the opening angle may be detected by using the strength of magnetic force. Specifically, a magnetic force sensor is provided in the lower housing 11. The speaker 43 in the upper housing 21 includes a magnet as a component. Therefore, the magnetic force sensor is provided so as to face the speaker 43 when the game apparatus 10 is closed. The opening angle is determined by the magnetic force sensor detecting the strength of magnetic force.

Alternatively, the opening angle may be detected by using an image shot by the inner imaging section 24. In this case, for example, an attachment including a small mirror is used, and is attached in the vicinity of the inner imaging section 24 as shown in FIG. 24. By the attachment being attached, the shooting direction of the inner imaging section 24 becomes the downward direction from the inner imaging section 24 owing to reflection by the mirror. In this way, if the shooting direction of the inner imaging section 24 is changed to the downward direction by using the attachment, an image shot by the inner imaging section 24 changes in accordance with the opening angle of the game apparatus 10. The opening angle of the game apparatus 10 is estimated by analyzing the shot image.

In addition, in the above embodiments, an example where the gyrosensor 39 is provided in the lower housing 11 is described. However, the present invention is not limited thereto, and the gyrosensor may be provided in any one of the upper housing 21 and the lower housing 11. For example, the gyrosensor may be provided in the upper housing 21, and the orientation of the upper housing 21 may be calculated based on an output from the gyrosensor. Then, the orientation of the lower housing 11 may be estimated by adding the offset described above to the orientation of the upper housing 21. Moreover, an image to be displayed on the lower LCD 12 may be changed in accordance with the estimated orientation of the lower housing

In addition, in the above embodiments, the gyrosensor 39 is used for calculating the orientation of the lower housing 11. However, the present invention is not limited thereto, and a movement sensor, other than a gyrosensor described above, that can detect the orientation of the lower housing 11 may be used. For example, the orientation may be calculated by using an acceleration sensor. Alternatively, a plurality of sensors may be used. In the above example, a gyrosensor and an acceleration sensor may be provided in the lower housing 11, and the orientation of the lower housing 11 may be calculated by using both the sensors.

Alternatively, the orientation of the lower housing 11 relative to the gravity direction may be detected, and an image based on the gravity direction may be displayed. In the case where, for example, the gyrosensor 39 is used as a movement sensor, an initial orientation of the lower housing 11 may be defined, and a predetermined direction based on the initial orientation may be set as the gravity direction. The initial orientation is, for example, the orientation of the lower housing 11 as it is when the game apparatus 10 is placed on a floor such that the outer side surface of the lower housing 11 is in contact with the floor. In this case, the direction of the outer side surface of the lower housing 11 is set as the gravity direction. On the other hand, in the case where the acceleration sensor is used as a movement sensor, the gravity direction (the direction in which the gravity acceleration is applied) may be detected in the state in which the game apparatus 10 is substantially at rest. Then, a game image based on the detected gravity direction may be displayed. For example, an image of a virtual space may be displayed such that the gravity direction in the real world and the gravity direction in the virtual space always coincide with each other.

In the case where, for example, both a gyrosensor and an acceleration sensor are provided in the lower housing 11, the above image display processing using the gravity direction may calculate the gravity direction and the orientation of the lower housing 11, by using only the gyrosensor, or by using only the acceleration sensor. Alternatively, the gravity direction may be detected by using the acceleration sensor, and the orientation of the lower housing 11 may be detected by using the gyrosensor.

In addition, in the above embodiments, one apparatus (game apparatus 10) executes the game processing based on the orientation of the upper housing 21 which is calculated by using the offset. However, in other embodiments, an information processing system including a plurality of information processing apparatuses may execute the above steps of processing. For example, in an information processing system including: a terminal, apparatus (in the above embodiments, the game apparatus 10); and a server apparatus capable of communicating with the terminal apparatus via a network, the server apparatus may execute a part of the above steps of processing (for example, the terminal apparatus may execute processing up to the step of setting the offset, and the server apparatus may execute game processing using the offset). Alternatively, in the information processing system including: a terminal apparatus; and a server apparatus capable of communicating with the terminal apparatus via a network, the server apparatus may execute principal steps of processing among the above steps of processing, and the terminal apparatus may execute a part of the above steps of processing. Alternatively, in the information processing system, the server apparatus may include a plurality of information processing apparatuses, and the plurality of information processing apparatuses may share steps of processing to be executed by the server apparatus.

While the invention has been described in detail, the foregoing description is in all aspects illustrative and not restrictive. It will be understood that numerous other modifications and variations can be devised without departing from the scope of the invention.

What is claimed is:

1. An information processing apparatus comprising:
a first housing including an orientation detection section for detecting an orientation;
a second housing including a first screen section for displaying a predetermined image, the second housing being connected to the first housing such that a relative orientation of the second housing with respect to the first housing can be changed;
a second housing orientation calculation section for calculating second housing orientation data indicating the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data; and
a display processing section for performing predetermined display processing for the first screen section, based on the second housing orientation data.

2. The information processing apparatus according to claim 1, further comprising:
a relative orientation information inputting section for causing a player to input relative orientation information indicating the relative orientation of the second housing with respect to the first housing; and
an offset setting section for setting the value of the predetermined offset, based on the relative orientation information inputted by the player,
wherein the second housing orientation calculation section calculates the second housing orientation data by using the predetermined offset set by the offset setting section.

3. The information processing apparatus according to claim 2, wherein
the information processing apparatus is a foldable-type information processing apparatus including the first housing and the second housing connected to each other so as to be openable and closable, and
the relative orientation information inputting section causes the player to input, as the relative orientation information, a value indicating a relative opening angle of the second housing with respect to the first housing.

4. The information processing apparatus according to claim 1, further comprising:
a relative orientation detection section for detecting a relative orientation of the second housing with respect to the first housing, and outputting the relative orientation as relative orientation information; and
an offset setting section for setting, as the predetermined offset, a value corresponding to the relative orientation of the second housing which is indicated by the relative orientation information,
wherein the second housing orientation calculation section calculates the second housing orientation data by using the predetermined offset set by the offset setting section.

5. The information processing apparatus according to claim 4, wherein
the relative orientation detection section outputs, as the relative orientation information, information indicating a relative direction of the second housing with respect to the first housing.

6. The information processing apparatus according to claim 4, wherein
the information processing apparatus is a foldable-type information processing apparatus including the first housing and the second housing connected to each other so as to be openable and closable, and
the relative orientation detection section detects a relative opening angle of the second housing with respect to the first housing, and outputs the relative opening angle as the relative orientation information.

7. The information processing apparatus according to claim 1, wherein
the display processing section includes:
a camera setting section for setting a shooting direction of a virtual camera placed in a virtual space; and
an image outputting section for outputting an image of the virtual space shot by the virtual camera to the first screen section, and
the camera setting section sets the shooting direction of the virtual camera in accordance with an orientation of the first screen section, which orientation is calculated based on the relative orientation of the second housing or a variation in the relative orientation.

8. The information processing apparatus according to claim 1, wherein
the first housing further includes an operation section for designating a movement direction of a player object in a virtual space, and
the display processing section includes:
an image outputting section for outputting, to the first screen section, an image, of the virtual space in which at least the player object is present, that is shot by the virtual camera; and
a movement direction adjustment section for varying a correspondence relationship between the movement direction of the player object in the virtual space, and an input direction of the operation section, in accordance with the detected data, or in accordance with the orientation of the first housing or the variation in the orientation, which orientation is calculated based on the detected data.

9. The information processing apparatus according to claim 1, wherein
the first housing further includes a second screen section for displaying a predetermined image, and
the display processing section performs predetermined display processing for the second display section, based on the first housing orientation data.

10. The information processing apparatus according to claim 9, wherein
the display processing section includes:
a camera setting section for setting a shooting direction of a virtual camera placed in a virtual space; and
an image outputting section for outputting an image of the virtual space shot by the virtual camera to each of the first screen section and the second screen section,
the camera setting section sets, as a first shooting direction, the shooting direction of the virtual camera corresponding to a direction of the first screen section calculated based on the second housing orientation data, and sets, as a second shooting direction, the shooting direction of the virtual camera corresponding to a direction of the second screen section calculated based on the first housing orientation data, and
the image outputting section outputs, to the first screen section, an image of the virtual space shot in the first shooting direction, and outputs, to the second screen section, an image of the virtual space shot in the second shooting direction.

11. The information processing apparatus according to claim 1, further comprising a gravity direction calculation section for calculating a gravity direction, based on the detected data outputted by the orientation detection section,
wherein the display processing section performs the predetermined display processing, based on the second housing orientation data and the gravity direction.

12. The information processing apparatus according to claim 11, wherein
the orientation detection section includes an angular velocity sensor, and
the gravity direction calculation section calculates, as the gravity direction, a predetermined direction defined when the first housing is in a predetermined orientation.

13. The information processing apparatus according to claim 11, wherein
the orientation detection section includes an acceleration sensor, and
the gravity direction calculation section detects a gravity acceleration in a state in which the first housing is substantially at rest, thereby calculating the gravity direction.

14. The information processing apparatus according to claim 11, wherein
the orientation detection section includes at least an angular velocity sensor and an acceleration sensor,
the detected data includes angular velocity data outputted by the angular velocity sensor, and
the gravity direction calculation section calculates the gravity direction, based on an output from the acceleration sensor.

15. The information processing apparatus according to claim 1, wherein
the orientation detection section includes at least one of an angular velocity sensor and an acceleration sensor.

16. A computer-readable storage medium having stored therein an information processing program that is executed by a computer of an information processing apparatus, which information processing apparatus includes: a first housing including an orientation detection section for detecting an orientation; and a second housing including a first screen section for displaying a predetermined image, the second housing being connected to the first housing such that a relative orientation of the second housing with respect to the first housing can be changed, the information processing program causing the computer to function as:
second housing orientation calculation means for calculating second housing orientation data indicating the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data; and
display processing means for performing predetermined display processing for the first screen section, based on the second housing orientation data.

17. An information processing method used in an information processing apparatus, which information processing apparatus includes: a first housing including an orientation detection section for detecting an orientation; and a second housing including a first screen section for displaying a predetermined image, the second housing being connected to the first housing such that a relative orientation of the second housing with respect to the first housing can be changed, the information processing method comprising:
a second housing orientation calculation step of calculating the relative orientation of the second housing or a variation in the relative orientation, based on a value obtained by adding a predetermined offset to detected data outputted by the orientation detection section, or to first housing orientation data indicating an orientation of the first housing or a variation in the orientation, which orientation is calculated based on the detected data; and
a display processing step of performing predetermined display processing for the first screen section, based on the relative orientation of the second housing or the variation in the relative orientation.

18. An information processing system comprising:
a first housing including orientation detection means for detecting an orientation;
a second housing including a screen for displaying a predetermined image, the second housing being connected to the first housing such that a relative orientation of the second housing with respect to the first housing can be changed;
second housing orientation calculation means for calculating second housing orientation data indicating the relative orientation of the second housing or a variation in the relative orientation, based on a value obtained by adding a predetermined offset to detected data outputted by the orientation detection means, or to first housing orientation data indicating an orientation of the first housing or a variation in the orientation, which orientation is calculated based on the detected data; and
display processing means for performing predetermined display processing for the first screen section, based on the second housing orientation data.
